(19) United States
(12) Patent Application Publication
(10) Pub. No.: US 2024/0355140 A1
(43) Pub. Date: Oct. 24, 2024

(54) LIGHTWEIGHT REAL-TIME EMOTION ANALYSIS METHOD INCORPORATING EYE TRACKING

(71) Applicant: DALIAN UNIVERSITY OF TECHNOLOGY, Ddalian, Liaoning (CN)

(72) Inventors: Xin YANG, Dalian, Liaoning (CN); Xiaopeng WEI, Dalian, Liaoning (CN); Bo DONG, Dalian, Liaoning (CN); Haiwei ZHANG, Dalian, Liaoning (CN)

(21) Appl. No.: 18/038,611

(22) PCT Filed: Jun. 20, 2022
(86) PCT No.: PCT/CN2022/099657

§ 371 Date: May 24, 2023

(51) Int. Cl. G06V 40/20; G06T 7/20; G06T 7/70; G06V 10/764; G06V 10/77; G06V 10/82; G06V 40/18

(52) U.S. Cl. CPC G06V 40/20; G06T 7/20; G06T 7/70; G06V 10/764; G06V 10/7715; G06V 10/82; G06V 40/193; G06T 2207/30201

(57) ABSTRACT

The present invention belongs to the technical field of computer vision, and proposes a lightweight real-time emotion analysis method incorporating eye tracking. In the method, gray frames and event frames that have synchronized time are acquired through event-based cameras and respectively input to a frame branch and an event branch; the frame branch extracts spatial features by convolution operations, and the event branch extracts temporal features through conv-SNN blocks; the frame branch has a guide attention mechanism for the event branch; and the spatial features and the temporal features are integrated by fully connected layers, The final output is the average of the n fully connected layer outputs, which represents the final expression. The method can recognize the emotional expression of any stage in various complex light changing scenarios; and in the case of limited accuracy loss, the emotion recognition time is shortened to achieve “real-time” user emotion analysis.

### TECHNICAL FIELD

The present invention relates to the technical field of computer vision, and particularly relates to a lightweight real-time emotion analysis method incorporating eye tracking.

### BACKGROUND

In recent years, with the rapid development of emotional computing technologies, human-computer emotional interaction and emotional robots have become a research hotspot in the field of human-computer interaction and emotional computing.

Emotional computing has a broad application prospect not only in distance education, medical care, intelligent driving and other fields, but also in smart eyewear devices such as Google Glass and HoloLens and some head-mounted intelligent devices such as an augmented reality (AR) device. The AR device enables users to interact with various virtual objects on the web in the real world, for example, by sensing user emotions and events or scenarios that users see at the moment to guide advertisement design and putting. Researches on the expression of human emotions can also help give smart glasses the ability to understand, express, adapt to and respond to human emotions.

### (1) Wearable Emotion Sensing Systems

Currently, in wearable devices, various biological signals have been explored and used to capture the emotional state of a person. Long-term heart rate variability (HRV) is closely related to emotional patterns, brain activities recorded by electroencephalographic (EEG) transducers are also widely believed to be related to emotions, and electromyography (EMG) transducers are used to reflect facial expressions based on measured muscle contractions, all of which make a wearable emotion detection device possible. However, all of these signals require corresponding transducers to come into direct contact with the skin of a user, which greatly affects the movement of the user. Moreover, the reliability of the measured signals is low due to the displacement of the transducers and the interference of muscles during the movement of the user. Pupillometry in Psychology, physiology, and function is another commonly used biological indicator of emotions. However, the reliability of pupillometry may be significantly affected by ambient light conditions in addition to expensive commercial equipment. In this project, an event-based camera is used to shoot the human eyes, and the emotional state of the user is judged according to the movement of the action unit of the eyes during emotional expression. The method does not require direct contact with the skin and can also deal with degraded lighting conditions, such as a scenario with a higher dynamic range, which is a promising wearable emotion recognition scheme.

The event-based camera is a biomimetic sensor that asynchronously measures changes in light intensity in a scenario and then outputs events, thus providing very high temporal resolution (up to 1 MHz) with very low power consumption. Because the changes in light intensity are calculated on a logarithmic scale, the camera can operate within a higher dynamic range (140 dB). When the pixel light intensity of the logarithmic scale changes above or below the threshold, the event-based camera is triggered to form “ON” and “OFF” events. Compared with the traditional frame-based camera, the event-based camera has excellent characteristics of high temporal resolution, higher dynamic range, low power consumption and high pixel bandwidth, and can effectively deal with the significant influence of various ambient light conditions. Therefore, the present invention uses the event-based camera as a transducer to shoot eye movement videos for emotion recognition under various ambient light conditions.

### (2) Facial Emotion Recognition

Facial emotion recognition has received significant attention in computer graphics and computer vision. In a virtual reality environment, the recognized facial expressions can drive facial expressions of a virtual character and help facial reenactment for efficient social interactions. Most facial emotion recognition methods require a full face as input, focusing on effective learning of facial features, fuzzy labeling of facial expression data, face occlusion and how to use temporal cues. To achieve more accurate emotion recognition, in addition to visual cues, some methods make use of other information such as context information and other patterns such as depth information. The accuracy of deep learning-based methods is significantly higher than that of traditional methods. However, due to high complexity of computing and a large number of parameters, a deep neural network requires a lot of computing resources, which cannot be satisfied by the limited computing resources of smart glasses. After such device is worn, it is often difficult to capture a complete facial expression and obtain a complete face image due to the occlusion of the device, which makes the emotion recognition algorithm of the deep neural network based on a full face image not applicable to AR application scenarios. Another direction is to identify different emotional expressions by only using images from the eye area. Steven et al. develops an algorithm in Classifying facial expressions in VR using eye-tracking cameras, and infers emotional expressions based on images of both eyes captured with an infrared gaze-tracking camera inside a virtual reality headset. The method requires personalized average neutral images to reduce individual differences in appearance. Wu et al. proposes an infrared single-eye emotion recognition system EMO in Real-time emotion recognition from single-eye images for resource-constrained eyewear devices, and the system also requires personalized initialization. A reference feature vector of each motion is created for each user. Assuming an input framework, EMO relies on a feature matching scheme to find the closest reference feature, and assigns the label of the matched reference feature to the input frame as the emotion prediction thereof. However, the required personalization may significantly affect the user experience. Furthermore, neither of the two methods leverages temporal cues, which are essential for emotion recognition missions. In contrast, the method uses a spiking neuron network to extract temporal information and improves the accuracy of emotion recognition in combination with spatial cues.

### SUMMARY

The present invention proposes a lightweight real-time emotion analysis method incorporating eye tracking, which can effectively recognize emotions based on any part of a given sequence through an eye emotion recognition network (SEEN). Based on deep learning, the method uses the event stream and the gray frames output by the event-based camera for emotion recognition based on eye movement tracking. In essence, the proposed SEEN utilizes a special design: an SNN-based architecture captures informative micro-temporal clues from an event domain based on spatial guidance obtained from the frame domain. The required inputs from the event domain and the frame domain will be simultaneously provided by the event-based camera. The proposed SEEN meets the following two basic requirements: a) decoupling spatial and temporal information from the sequence length, and b) effectively executing the guidance obtained by the frame domain into the temporal information extraction process.

The present invention has the following technical solution: a lightweight real-time emotion analysis method incorporating eye tracking, in which gray frames and event frames that have synchronized time are acquired through event-based cameras and respectively input to a frame branch and an event branch; the frame branch extracts spatial features by convolution operations, and the event branch extracts temporal features through conv-SNN blocks; the frame branch has a guide attention mechanism for the event branch; and the spatial features and the temporal features are integrated by fully connected layers, The final output is the average of the n fully connected layer outputs, which represents the final expression.

The specific steps are as follows:
Step 1: extracting expression-related spatial features through the frame branch for a gray frame sequence;
The purpose of the frame branch is to extract the expression-related spatial features through the provided gray frame sequence.

The extraction of the spatial features is based on the first frame and the last frame of the given gray frame sequence; and after the two gray frames are superimposed, the spatial features are gradually extracted by an adaptive multiscale perception module (AMM) and two additional convolution layers.

The adaptive multiscale perception module uses three convolution layers with different kernel sizes to extract multiscale information of the gray frames, and then uses an adaptive weighted balance scheme to balance the contribution of features of different scales; and then a convolution layer with the convolution kernel size of 1 is used to integrate weighted multiscale features. The adaptive multiscale perception module is specifically embodied as formula (1) to formula (3):

$${ℱ}_{m} = {C}_{1} ( [ {w}_{i} {ℱ}_{i} ] ) , \qquad ( 1 )$$

$${w}_{i} = σ ( M ( {ℱ}_{i} ) ) , \qquad ( 2 )$$

$${ℱ}_{i} = {C}_{i} ( {C}_{1} ( [ {ℱ}_{f} , {ℱ}_{l} ] ) ) , \qquad ( 3 )$$

wherein [·] represents channel connection; Cᵢ represents a i*i convolution layer; C₁ represents a 1*1 convolution layer; M is a multilayer perceptron operator, comprising a linear input layer, a batch normalization layer, an ReLU activation function and a linear output layer; σ is a Softmax function; Fᵢ represents a multiscale frame feature; the sum of all adaptive weights wᵢ is 1; and [symbol] _{f}, [symbol] ₗ respectively represent the first gray frame and the last gray frame.

Based on [symbol] ₘ, two additional convolution layers generate a [symbol] _{f}, [symbol] ₗ-based final frame spatial feature [symbol] , as shown in formula (4):

$$ℱ = {C}_{3} ( {C}_{3} ( {ℱ}_{m} ) ) \qquad ( 4 )$$

wherein C₃ represents a 3*3 convolution layer;
Step 2: extracting temporal features through the event branch for event frames;
The event branch is based on a spike CNN architecture, comprising three conv-SNN blocks; each conv-SNN block comprises a convolution layer and an LIF-based SNN layer which are connected in sequence; in the first conv-SNN block, the input event frames are converted to membrane potential by the convolution layer and input to the SNN layer, and the output of the SNN layer is spike; and the spike is converted to membrane potential by convolution layers of the other two conv-SNN blocks and input to the subsequent SNN layer;
The event branch processes n event frames in chronological order, and updates the weights of the convolution layers on the event branch according to the frame branch; and the structure of the convolution layers on the event branch is symmetric with that on the frame branch, and the convolution layers in the symmetric positions are set up in the same way as that on the frame branch, as shown in formula (5);

$${θ}_{{E}_{t}} = k {θ}_{{E}_{t - 1}} + ( 1 - k ) {θ}_{G} \qquad ( 5 )$$

wherein θ_{G} represents the parameter of the convolution layer on the frame branch, and θ_{E}_{ₜ₋₁} represents the parameter of the convolution layer of the event branch at timestamp t; and k is a parameter ranging from 0 to 1, representing the weight contributed by the parameters of the two branches when the parameter of the event branch is updated;
The membrane potential V^{t,l} of a neuron at the l^{th} layer of the timestamp t is expressed as formula (6) to formula (9);

$${V}^{t , l} = {H}^{t , l} + C 𝒜 ( {Z}^{t , l - 1} ) \qquad ( 6 )$$

$${Z}^{t , l} = f ( {V}^{t - 1 , l} - {𝒱}_{t h} ) \qquad ( 7 )$$

$${H}^{t , l} = ( α {V}^{t - 1 , l} ) ( 1 - {Z}^{t , l - 1} ) \qquad ( 8 )$$

$${Z}^{t , 0} = {E}_{t} \qquad ( 9 )$$

wherein f(·) is a step function; [symbol] ₕ is the threshold of the membrane potential; α is the decay of an LIF neuron; Eₜ is a t^{th} event frame; and C [symbol] represents the operation of the adaptive multiscale perception module or the two additional convolution layers;
In order to effectively integrate spatial features and temporal features, a guide attention mechanism (GA) is set to enhance spatio-temporal information, which is mathematically expressed as formula (10) to formula (11);

$${G}^{t} = ψ ( β ( {C}_{7} ( [ Max ( {D}^{t} ) , Mean ( {D}^{t} ) ] ) ) ) {V}^{t , l = 3} + {V}^{t , l = 3} \qquad ( 10 )$$

$${D}^{t} = [ ℱ , {V}^{t , l = 3} ] \qquad ( 11 )$$

wherein C₇ represents a 7*7 convolution layer, and β is a batch normalization layer and an ReLU function; ψ is a sigmoid function; Max and Mean respectively represent avgpooling and avgpooling of features in the channel dimension; and Gt is a dense feature generated by the attention mechanism on the classifier of the timestamp t;
Step 3: carrying out classification based on classifiers;
Two SNN-based fully connected layers are used as classifiers; and the input of the classifier at the timestamp t is defined as formula (12):

$${I}^{t} = f ( ℱ - {𝒱}_{t h} ) + f ( {G}^{t} - {𝒱}_{t h} ) \qquad ( 12 )$$

At the last timestamp n, the mean value of output peaks O^{t} of the last fully connected layer from 1 to n at all timestamps is calculated, S is obtained from the Softmax function, and the scores of seven expressions are represented by S;

$$S = σ ( \frac{1}{n} {Σ}_{t = 1}^{n} {O}^{t} ) \qquad ( 13 )$$

wherein σ is a Softmax function; and the seven expressions are happiness, sadness, surprise, fear, disgust, anger and neutrality.
Three convolution layers with different kernel sizes of the adaptive multiscale perception module are respectively 3*3, 5*5 and 7*7.

In the present invention, the frame branch and the event branch are used to respectively process gray frames and event frames that have synchronized time. The frame branch extracts spatial features through several simple convolution operations, and the event branch extracts temporal features through three conv-SNN blocks, wherein a guide attention mechanism is designed for the frame branch relative to the event branch. Finally, the spatial features and the temporal features are integrated by using two SNN-based fully connected layers. It should be noted that the event branch is a loop structure, and n input event frames shall enter the event branch in sequence to execute the above steps.

The present invention has the following beneficial effects: the present invention realizes a lightweight real-time emotion analysis method incorporating eye tracking based on augmented reality eyewear devices. The method can recognize any stage of emotional expression by eye tracking through the event-based camera, and carry out tests with indefinite sequence length. The method extracts emotion-related spatial and temporal features through single-eye images contained in eye movement videos, identifies the current user emotions, and runs stably in various complex light changing scenarios. Meanwhile, the method has very low complexity and a few calculating parameters and can run stably on devices with limited resources. Moreover, in the case of limited accuracy loss, the emotion recognition time is greatly shortened to achieve “real-time” user emotion analysis. The present invention applies the momentum updating mode of contrast learning in conv-SNN for the first time. Extensive experimental results show that the method is superior to other advanced methods. Thorough ablation researches demonstrate the effectiveness of each method of the key components of SEEN.

### DESCRIPTION OF DRAWINGS

FIG. 1 is an overall structural diagram of the method.

FIG. 2 is a schematic diagram of an adaptive multiscale perception module (AMM).

FIG. 3 is a schematic diagram of a guide attention (GA) mechanism.

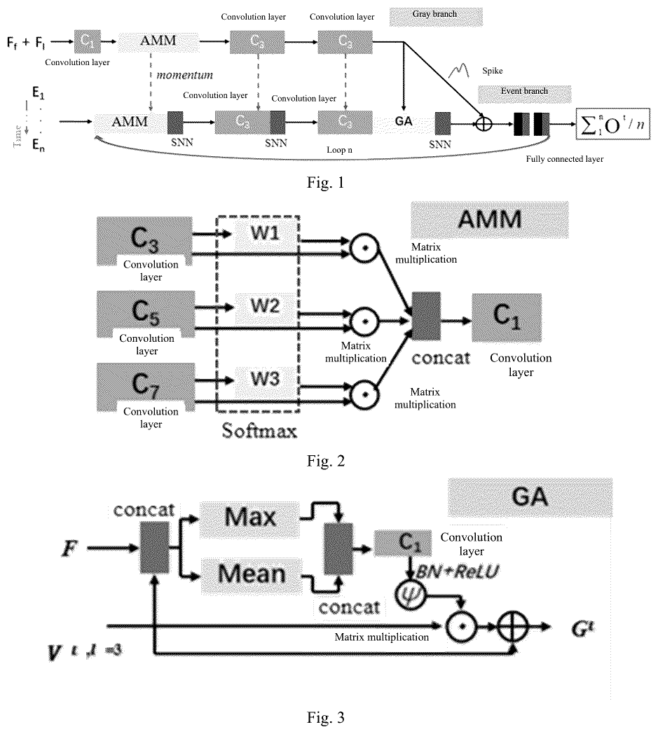

### DETAILED DESCRIPTION

The present invention is further described below in detail in combination with specific embodiments. However, the present invention is not limited to the specific embodiments.

A lightweight real-time emotion analysis method incorporating eye tracking is used for data set acquisition, data pre-processing, and training and testing of network models.

The present invention collects the first frame event-based single-eye emotion data set (FESEE). The data set is based on the DAVIS346 event-based camera to capture eye movement data, and a dynamic vision sensor (DVS) and an active pixel sensor (APS) are equipped. The two sensors can work in parallel and simultaneously capture gray frames and corresponding asynchronous events. The DVAIS346 camera is connected to the headset through a mounting arm to simulate HMD. A total of 83 volunteers are recruited and required to naturally form seven different emotional expressions.

The data acquisition method proposed by the present invention does not require any active light source, but only relies on ambient lighting, which is a more realistic setup based on the application of augmented reality. Therefore, the FESEE data set is collected under four different lighting conditions: Normal light, overexposure, low-light and higher dynamic range (HDR). Each collected emotion is a video sequence, with the average length of 56 frames. The length of the collected sequences vary significantly, from 17 to 108 frames, reflecting the fact that emotions continued to vary from person to person. The total length of the FESEE data set is 1.18 hours and is composed of 127,427 gray frames and 127,427 event frames. The event frames are superposed in a way that events within the interval from the start time to the end time of each gray frame in the gray sequence are extracted, and assigned with different pixel values according to the polarity of the events for superposition. Specifically, a point with the polarity of “ON” is assigned with a pixel value of 0, a point with the polarity of “OFF” is assigned with a pixel value of 255, and points with no event are all assigned with a pixel value of 127. All the images are cropped to a size of 180*180.

First, it is necessary to select n continuous and synchronous gray frames and event frames from a random position of each sequence of the data set. Then the gray frames and the event frames are uniformly adjusted to a size of 90*90, and normalized according to the mean value and variance of data. To train the proposed SEEN, a cross entropy is used as a loss function. The network is implemented in PyTorch. The model is trained with a stochastic gradient descent (SGD) optimizer with a momentum of 0.9. The batch size of the model is set to 180. The initial learning rate is 0.015, and each period is adjusted to 0.94 time of the original period. In the conv-SNN network, the threshold is set to 0.3, and the decay is set to 0.2. The momentum parameter is set to 0.5.

1. A lightweight real-time emotion analysis method incorporating eye tracking, wherein gray frames and event frames that have synchronized time are acquired through event-based cameras and respectively input to a frame branch and an event branch; the frame branch extracts spatial features by convolution operations, and the event branch extracts temporal features through conv-SNN blocks; the frame branch has a guide attention mechanism for the event branch; and the spatial features and the temporal features are integrated by fully connected layers, the final output is the average of the n fully connected layer outputs, which represents the final expression;
the specific steps are as follows:
step 1: extracting expression-related spatial features through the frame branch for a gray frame sequence;
the extraction of the spatial features is based on the first frame and the last frame of the given gray frame sequence; and after the two gray frames are superimposed, the spatial features are gradually extracted by an adaptive multiscale perception module and two additional convolution layers;
the adaptive multiscale perception module uses three convolution layers with different kernel sizes to extract multiscale information of the gray frames, and then uses an adaptive weighted balance scheme to balance the contribution of features of different scales; then a convolution layer with the convolution kernel size of 1 is used to integrate weighted multiscale features; and the adaptive multiscale perception module is specifically embodied as formula (1) to formula (3):
$${ℱ}_{m} = {C}_{1} ( [ {w}_{i} {ℱ}_{i} ] ) , \qquad ( 1 )$$
$${w}_{i} = σ ( M ( {ℱ}_{i} ) ) , \qquad ( 2 )$$
$${ℱ}_{i} = {C}_{i} ( {C}_{1} ( [ {ℱ}_{f} , {ℱ}_{l} ] ) ) , \qquad ( 3 )$$
wherein [·] represents channel connection; Cᵢ represents a i*i convolution layer; C₁ represents a 1*1 convolution layer; M is a multilayer perceptron operator, comprising a linear input layer, a batch normalization layer, an ReLU activation function and a linear output layer; σ is a Softmax function; Fᵢ represents a multiscale frame feature; the sum of all adaptive weights wᵢ is 1; and [symbol] _{f}, [symbol] ₗ respectively represent the first gray frame and the last gray frame;
based on [symbol] ₘ, two additional convolution layers generate a [symbol] _{f}, [symbol] l-based final frame spatial feature [symbol] , as shown in formula (4):
$$ℱ = {C}_{3} ( {C}_{3} ( {ℱ}_{m} ) ) \qquad ( 4 )$$
C₃ represents a 3*3 convolution layer;
step 2: extracting temporal features through the event branch for event frames;
the event branch is based on a spike CNN architecture, comprising three conv-SNN blocks; each conv-SNN block comprises a convolution layer and an LIF-based SNN layer which are connected in sequence; in the first conv-SNN block, the input event frames are converted to membrane potential by the convolution layer and input to the SNN layer, and the output of the SNN layer is spike; and the spike is converted to membrane potential by convolution layers of the other two conv-SNN blocks and input to the subsequent SNN layer;
the event branch processes n event frames in chronological order, and updates the weights of the convolution layers on the event branch according to the frame branch; and the structure of the convolution layers on the event branch is symmetric with that on the frame branch, and the convolution layers in the symmetric positions are set up in the same way as that on the frame branch, as shown in formula (5);
$${θ}_{{E}_{t}} = k {θ}_{{E}_{t - 1}} + ( 1 - k ) {θ}_{G} \qquad ( 5 )$$
wherein θ_{G} represents the parameter of the convolution layer on the frame branch, and θ_{E}_{ₜ₋₁} represents the parameter of the convolution layer of the event branch at timestamp t; and k is a parameter ranging from 0 to 1, representing the weight contributed by the parameters of the two branches when the parameter of the event branch is updated;
the membrane potential V^{t,l} of a neuron at the l^{th} layer of the timestamp t is expressed as formula (6) to formula (9);
$${V}^{t , l} = {H}^{t , l} + C 𝒜 ( {Z}^{t , l - 1} ) \qquad ( 6 )$$
$${Z}^{t , l} = f ( {V}^{t - 1 , l} - {𝒱}_{t h} ) \qquad ( 7 )$$
$${H}^{t , l} = ( α {V}^{t - 1 , l} ) ( 1 - {Z}^{t , l - 1} ) \qquad ( 8 )$$
$${Z}^{t , 0} = {E}_{t} \qquad ( 9 )$$
wherein f(·) is a step function; [symbol] ₜₕ is the threshold of the membrane potential; α is the decay of an LIF neuron; Eₜ is a t^{th} event frame; and C [symbol] represents the operation of the adaptive multiscale perception module or the two additional convolution layers;
in order to effectively integrate spatial features and temporal features, a guide attention mechanism is set to enhance spatio-temporal information, which is mathematically expressed as formula (10) to formula (11);
$${G}^{t} = ψ ( β ( {C}_{7} ( [ Max ( {D}^{t} ) , Mean ( {D}^{t} ) ] ) ) ) {V}^{t , l = 3} + {V}^{t , l = 3} \qquad ( 10 )$$
$${D}^{t} = [ ℱ , {V}^{t , l = 3} ] \qquad ( 11 )$$
Wherein C₇ represents a 7*7 convolution layer, and β is a batch normalization layer and an ReLU function; ψ is a sigmoid function; Max and Mean respectively represent avgpooling and avgpooling of features in the channel dimension; and Gt is a dense feature generated by the attention mechanism on the classifier of the timestamp t;
step 3: carrying out classification based on classifiers;
two SNN-based fully connected layers are used as classifiers; and the input of the classifier at the timestamp t is defined as formula (12):
$${I}^{t} = f ( ℱ - {𝒱}_{t h} ) + f ( {G}^{t} - {𝒱}_{t h} ) \qquad ( 12 )$$
at the last timestamp n, the mean value of output peaks O^{t} of the last fully connected layer from 1 to n at all timestamps is calculated, S is obtained from the Softmax function, and the scores of seven expressions are represented by S;
$$S = σ ( \frac{1}{n} {Σ}_{t = 1}^{n} {O}^{t} ) \qquad ( 13 )$$
wherein σ is a Softmax function; and the seven expressions are happiness, sadness, surprise, fear, disgust, anger and neutrality.

2. The lightweight real-time emotion analysis method incorporating eye tracking according to claim 1, wherein three convolution layers with different kernel sizes of the adaptive multiscale perception module are respectively 3*3, 5*5 and 7*7.
